(19) United States
(12) Patent Application Publication
(10) Pub. No.: US 2009/0139410 A1
(43) Pub. Date: Jun. 4, 2009

(54) Cooking Appliance

(75) Inventors: Ingo Bally, Traunstein (DE); Alexander Dinkel, Unterwoessen (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/087,967

(22) PCT Filed: Jan. 26, 2007
(86) PCT No.: PCT/EP2007/050763

§ 371 Date: Jul. 18, 2008

(30) Foreign Application Priority Data
Jan. 31, 2006 (DE) 102006004375.8

(51) Int. Cl. A47J 37/00; G08B 21/00

(52) U.S. Cl. 99/342; 340/665

(57) ABSTRACT

A cooking appliance, especially a built-in wall cooking appliance, which comprises at least one muffle, delimiting a cooking compartment and having a muffle opening, a door for closing said muffle opening and a drive device, controlled by a control device, for displacing the door and at least one switch which transmits actuation signals for determining a zero position of the door to the control device when the door touches the muffle. The control device is also configured in such a manner that the presence of the actuation signals of the at least one switch is required but not sufficient to determine the zero position.

The present invention relates to a cooking appliance, especially a built-in wall-mounted cooking appliance, which comprises at least one muffle, delimiting a cooking compartment and having a muffle opening, a door for closing said muffle opening and a drive device, controlled by a control device, for displacing the door, with the drive device including at least one drive motor, by means of which cables connected the door can be moved. The present invention also relates to an associated operating method.

DE 102 28 140 A1 and DE 102 28 141 A1 disclose built-in wall-mounted cooking appliances, in which the opening of a base unit door actuates a limit switch on the muffle frame, whereupon the drive unit is deactivated. It is disadvantageous here for the switch to have high switching point tolerances and thus a correct closure of the base unit door is not ensured. As a result, this can lead to an incorrect operation of the cooking appliance, for instance in the muffle heating up when the base unit door is still slightly open.

The object of the present invention is to provide a cooking appliance with a more reliable zero point determination.

The present object is achieved by the cooking appliance with the features of claim 1 as well as by a method as claimed in claim 11. Advantageous embodiments can be taken from the subclaims individually or in combination.

To this end, the cooking appliance, which is especially a built-in wall-mounted cooking appliance, but can also be a cooking appliance with an oven carriage, is provided with at least one muffle, delimiting a cooking compartment and having a muffle opening, a door for closing said muffle opening and a drive device, controlled by a control device, for displacing the door and at least one switch which transmits actuation signals to the control device when the door contacts the muffle. The control device is set up such that the actuation signals of the at least one switch are processed in order to establish a zero and/or closed position of the door.

The presence of the actuation signals of the at least one switch is required but not sufficient to determine a zero position and/or closed position of the door.

It is also advantageous if a zero position is determined, when the at least one switch is actuated and a measurement of a displacement path of the door simultaneously indicates that the zero position PO has been reached, at least within a certain tolerance range, e.g. ±1%. The displacement path can then also be reset to a predetermined zero point value. A ‘swallowing’ of sensor pulses within a tolerance range can thus be compensated for instance.

It is favorable here in terms of measuring technology if the displacement path is determined by measuring a number of revolutions of the motor or an associated drive or a fraction of this number. It is particularly favorable here if at least one sensor unit, especially a Hall sensor unit, is present and is connected to the control unit in order to measure the number of revolutions of a motor shaft or a fraction thereof. It is then also advantageous if the control unit, based on an initial zero position, counts the sensor pulses transmitted by the sensor unit when displacing the door and converts these into a displacement path.

In addition or alternatively, further conditions can also be used to determine the zero point position. It may be advantageous for instance if a zero position P0 is determined when the at least one switch is actuated and at the same time the door cannot be displaced further when actuating the drive device. This condition can occur in addition or alternatively to the condition of the measured displacement path. The stationary state of the base unit door and/or the drive device can be determined arbitrarily, for instance by measuring the motor or drive revolution speed, directly measuring the displacement speed of the base unit door, the motor power or the motor current etc.

The at least one switch can advantageously be two switches, which are attached in particular to one side of the cooking appliance in each instance, with a presence of the actuation signals of both switches being required but not sufficient to determine the zero position.

To avoid impairing the switching tolerance, the at least one switch is favorably fastened to the carcass and is actuated by the lifting element, especially by a telescopic rail.

It is particularly favorable if the zero position of the door is then typically determined by the control circuit in order to determine a zero position P0 of a door of a cooking appliance, if at the same time
(a) the at least one switch has been actuated and
(b) has been measured such that a displacement path of the door corresponds to the zero position P0 at least within a tolerance range (e.g. ±sensor pulses or ±0.1 cm) and/or
(c) the door cannot be displaced further in the case of an actuated drive device.

With condition (a) and at least one of the conditions (b1) and (b2), or a further condition for determining the zero point position P0, this position is prescribed and/or initialized as the new zero position P0.

The displacement path does not need to have a tolerance range however, but can also be fulfilled as a precise condition, e.g. the Hall pulse counter must then correspond precisely to the value for the zero point position.

It is particularly advantageous if a fault is determined and/or an associated fault routine is shut down, which can include a reversal of the door for instance, when at least one condition (a) applies and at least one of the other conditions (b1, b1) used to determine the zero position P0 does not apply or when the condition (a) does not apply but all other conditions (b1, b1) used to determine the zero position (P0) apply.

The actuation signals of the switch can be arbitrary, e.g. can include a high or low level.

In one embodiment of the cooking appliance, two lift cables are provided, each of which is fastened on one side to a side of the door. The lift cables are fed here through an insulation to a drive wheel of a drive motor, as a result of which they are linked to a motor shaft on opposite sides. Rotating the drive wheel causes the lift cables to be displaced linearly in the opposite direction, the door is displaced linearly accordingly. Using the lift cable drive in the cooking appliance results on the one hand in the advantage of a space-saving design, since the otherwise existing cable drum on the drive motor is no longer needed. Secondly, assembly and adjustment is significantly easier by comparison with the drive with the cable drum since the complicated winding onto the cable drum, for which a cable tightener is needed for instance, is omitted. The fact that the lift cables are connected to the door generally means that they can be fastened directly to the door or to an element connected to the door, e.g. a telescopic rod.

It is advantageous for improved operational reliability if each switching device is connected to a control switch, which is set up such that it recognizes a jam by evaluating the signals from the switching devices.

The invention can be used particularly advantageously in a built-in wall-mounted cooking appliance having a muffle opening on the base and a base unit door.

The invention is described in more detail below with reference to the embodiments shown in the appended schematic figures. The embodiments do not restrict the scope of the invention: in the Figures;

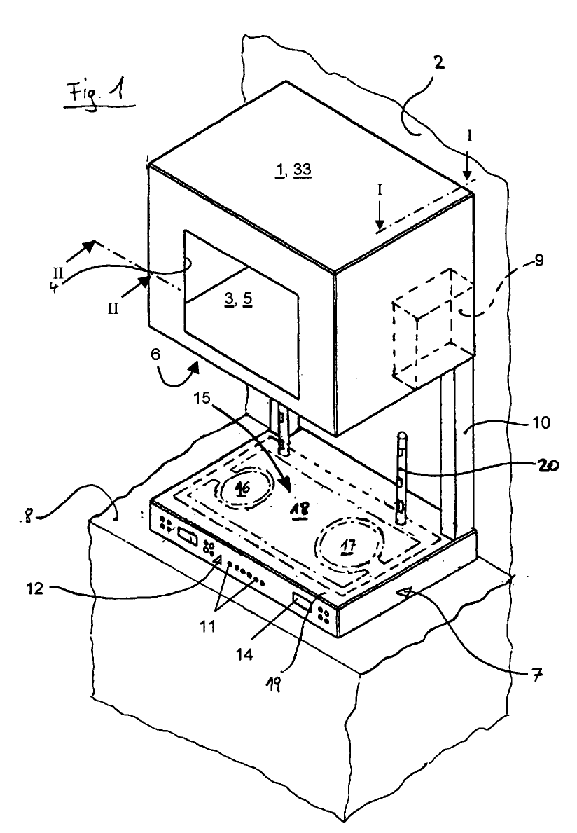

FIG. 1 shows a perspective view of a wall-mounted built-in cooking appliance having a lowered base unit door;

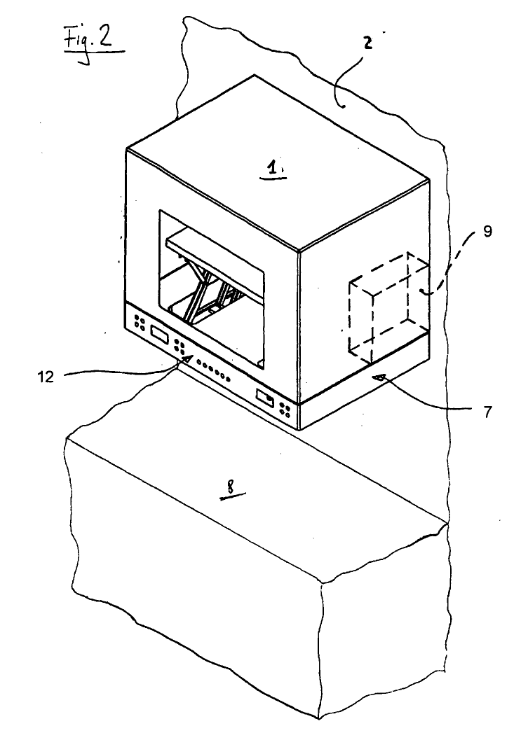

FIG. 2 shows a perspective view of the built-in wall-mounted cooking appliance a closed base unit door;

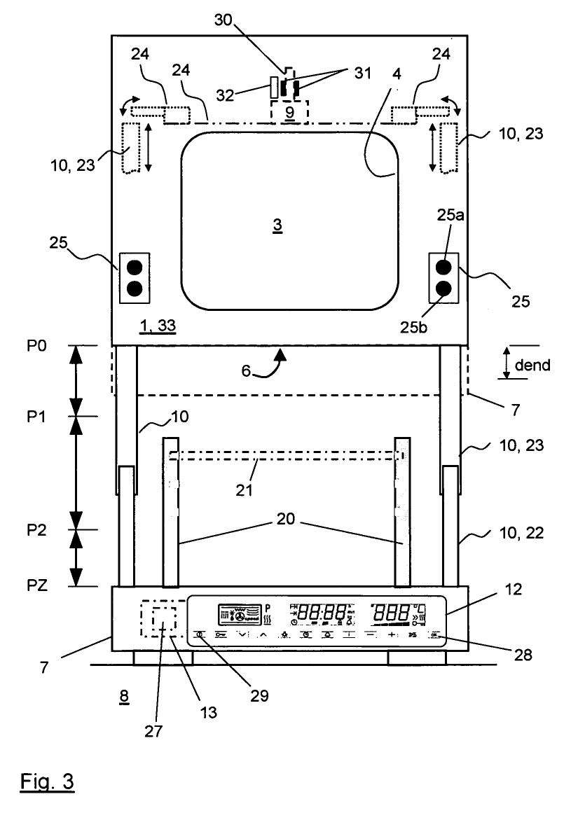

FIG. 3 shows a front view of a further embodiment of a built-in wall-mounted cooking appliance.

The figures are not necessarily drawn to scale for improved clarification of the individual elements.

FIG. 1 shows a built-in wall-mounted cooking appliance with a housing 1. The rear of the housing 1 is mounted to a wall 2 in the manner of a wall unit. A cooking compartment 3 is defined in the housing 1, it being possible to monitor said cooking compartment by way of a viewing window 4 introduced onto the front of the housing 1. FIG. 3 shows that the cooking compartment 3 is delimited by a muffle 5, which is provided with a heat-insulated casing (not shown) and that the muffle 5 has a muffle opening 6 on its base. The muffle opening 6 can be sealed with a base unit door 7. FIG. 1 shows the base unit door 7 dropped down, with it having its underside resting on a countertop 8 of a kitchen unit. To seal the cooking compartment 3, the base unit door 7 is to be displaced into the position shown in FIG. 2, the so-called “zero position”. In order to displace the base unit door 7, the built-in wall-mounted cooking appliance has a drive device 9, 10. The drive device 9, 10 has a drive motor 9, shown in FIGS. 1, 2 and 3 with dashed lines, said drive motor 9 being arranged between the muffle 5 and an outer wall of the housing 1. The drive motor 9 is arranged in the region of the rear of the housing 1 and is functionally connected, as shown in FIG. 1 or 3, to one pair of lifting elements 10, which are connected to the base unit door 7. Here, in accordance with the schematic side view from FIG. 3, each lifting element 10 is configured as a telescopic rod, which is attached on the one hand for instance to the base unit door 7 (for instance to a supporting bracket protruding from the top side of the base unit door 7) and on the other hand to a carcass 33 of the cooking appliance (for instance a cooking appliance bracket). In order to displace the base unit door 7, the drive motor 9 can be actuated with the aid of a control panel 12 and a control circuit 13, which is arranged on the front of the base unit door 7 in accordance with FIG. 1. As FIG. 3 shows, the control circuit 13 is located behind the control panel 12 within the base unit door 7. The control circuit 13, which is composed here of several spatially and functionally separated circuit boards which communicate by way of a communication bus, represents a central control unit for the device operation and controls and/or regulates e.g. a preheating, a displacement of the base unit door 7, a translation of user inputs, an illumination, an anti-jam protection system, a synchronization of the heating elements 16, 17, 18, 22 and much more.

FIG. 1 shows that a top side of the base unit door 7 has a cooking zone 15. Almost the entire surface of the cooking zone 15 is taken up with heating elements 16, 17, 18, which are shown in FIG. 1 with dots. FIG. 1 shows the heating elements 16, 17 of two differently sized cooking zone heating elements which are distanced from one another, whereas the heating element 18 is a surface heating element provided between the two cooking zone heating elements 16, 17, said surface heating element almost surrounding the cooking zone heating elements 16, 17.

In the exemplary embodiment shown, the heating elements 16, 17, 18 are configured as radiation heating elements, which are covered by a glass-ceramic plate 19. The glass-ceramic plate 19 is also equipped with assembly openings (not shown), through which sockets for holding retaining parts 20 for cooking appliance brackets 21 protrude, as also shown in FIG. 3.

FIG. 3 shows a schematic representation of a front view of the built-in wall-mounted cooking appliance not shown to scale, in which the base unit door 7 is resting on the countertop 9 in an open state. The closed state is shown with a dashed line.

In this embodiment, two switch panels 25 are located on the front side of the permanently attached housing 1. Each switch panel 25 has three push-buttons, namely an upper CLOSED-push-button 25a for a base door 7 moving upwards in the closing direction and an upper OPEN-push-button 25b for a base unit door 7 moving downwards in the opening direction. Without automatic operation (see below), the base unit door 7 only moves upwards by means of a continuous simultaneous pressing of the CLOSED keys 25a of both switch fields 25, if necessary; the base unit door 7 also moves downwards only by means of a continuous simultaneous pressing of the ON key 25b of both switch fields 25, if necessary (manual operation). As the user requires increased operational attention during manual operation, and both hands are used herefor, an anti-jam protection system is only optional.

In this exemplary embodiment, the control circuit 13 includes a storage unit 27 for storing at least one target and/or displacement position P0, P1, P2, PZ of the base unit door 7, preferably with volatile storage modules, e.g. DRAMS. If a target position P0, P1, P2, PZ is stored, the base unit door can automatically displace in the set direction following actuation of one of the keys 25a, 25b of the displacement switching fields 25, until the next target position is reached or one of the keys 25a, 25b is reactivated (automatic operation). In this exemplary embodiment, the lowest target position PZ corresponds to the maximum opening, the (zero) position corresponds to the closed state and P1 and P2 are freely adjustable intermediate positions. If the last target position is reached for one direction, manual operation must also be continued, if this is possible (the last final positions do not correspond to a maximally opened or the closed final state). Similarly, if no target position is stored for one direction, which would be the case for instance for an upward movement into the closed position, if only PZ is stored, but not P0, P1, P2, manual operation must then be used in this direction. If no target position is stored, e.g. in the case of a new installation or following a mains disconnection, no automatic operation is possible. If the base unit door 7 is moved during automatic operation, an anti-jam protection system is preferably activated.

A target position P0, P1, P2, Pz may be any position of the base unit door 7 between and including the zero position P0 (“closed position”) and the maximum opening position PZ. The maximum stored opening position PZ does not however have to be the position when resting on the countertop 8.

The drive motor 9 from FIG. 1 has at least one sensor unit 31, 32 on a motor shaft 30, if applicable arranged in front of or behind a drive, in order to measure a displacement path and/or a position and/or a speed of the base unit door 7. The sensor unit can include one or several induction, hall, opto, OFW sensors etc. for instance. Here, two hall (sub) elements (31) are offset by 180° for simple path and speed measurement purposes, in other words attached opposite to the motor shaft 30, and a hall sensor 32 is fixedly attached at a distance to this region of the motor shaft. If a Hall element 31 continues past the sensor 32 when rotating the motor shaft 30, a measuring and/or sensor signal is generated which is closely approximate to digital. With (not necessarily) two hall elements 31, two signals are emitted when the motor shaft 30 is rotated. Temporally evaluating these signals, e.g. their time difference allows the speed vL of the base unit door 7 to be determined for instance by way of comparison tables or a conversion in real-time in the control circuit 13. By adding and/or subtracting the measuring signals, knowledge relating to the displacement path between two sensor signals allows an absolute displacement path and/or an absolute position of the base unit door 7 to be determined.

Speed regulation allows the speed to be realized for instance by way of a PWM-controlled power semiconductor.

In order to determine the zero point, the path measurement is automatically readjusted by initialization in the zero position P0 of the base unit door 7 during each movement, so that a faulty sensor signal emission and/or acquisition is not passed on.

The zero point determination can be performed in different ways. The use of switches 24 alone is not optimum as a result of their comparatively high switching point tolerances.

In this embodiment, two switches 24 are attached to an overlay 34 of the carcass 33 (shown with a dotted line) such that they are actuated by the accelerating lifting mechanism 10 when the base unit door 7 is opened, if the base unit door 7 does not reach a predetermined gap width dend between the base unit door 7 and the muffle opening. The switches 24 lie here above the muffle 5, for cooling reasons on the carcass 33 at a distance from the walls of the muffle 5. The mechanical actuation of the switches 24 (see curved arrows) by the lifting mechanism 10, which is shown purely schematically here in an almost closed position prior to actuation, with the straight arrows indicating the associated movement direction, results, contrary to the direct actuation by the base unit door 7 for instance, in the advantage that a circuit is not impaired by a tipping or imprecision of the position of the base unit door 7. In addition, it is possible to dispense with a complicated thermal insulation of the switch, which would otherwise be necessary for instance with a circuit through the base unit door and/or the cooking zone forming the surface of the base unit door.

The switches 44 can also deactivate an anti-jam protection device when actuated.

The predetermined gap width dend amounts here to between 12 mm and 4 mm, preferably between 6 mm and 10 mm. The switches are duplicated for reliability purposes, only one switch may also be present for instance for cost-saving reasons.

The zero point determination is more reliable by using the measurement of the displacement path. If it is typically determined here that the displacement path is zero, in other words the zero position P0 should have been achieved, the base unit door 7 is stopped. The displacement path can be determined by counting the sensor pulses for instance. This can however lead to pulses being miscounted for instance, an passed on without further measures.

An additional method is one of establishing whether or not the base unit door is turning despite actuation of the motor 9. However in the near region, a jamming of the base unit door, whereby it stops, can falsely represent an incorrect zero point position.

In this embodiment, the zero point determination of the base unit door 7 is thus implemented by combining these methods. To ensure that the control circuit 13 determines the zero point determination P0 as such and thereupon constructively controls the movement of the base unit door 7 during a subsequent opening, both switches 24 must be first actuated and the displacement path, if necessary within a specific tolerance range, must secondly be measured as belonging to the zero position and/or the motor can no longer move, e.g. turn when closing the base unit door. In this embodiment, all three conditions must even be fulfilled. If this is the case, the control circuit 13 initializes the zero point position and resets e.g. the sensor pulse count to zero or another value predetermined for the zero position P0.

When fulfilling only one or two conditions, a fault message can be emitted and/or if necessary the base unit door 7 reversed. A fault message can be output if the sensor pulse count indicates a zero position P0, but the switches 24 are still not actuated or the motor moves across the tolerance range (e.g. to 1 to 4 sensor pulses, according for instance to a half and up to three revolutions of the motor shaft or a drive shaft).

The arrangement and makeup of the control circuit 13 is flexible and unrestricted here, it can thus include several printed circuit boards, e.g. a display printed circuit board, a control printed circuit board and a lift printed circuit board, which are spatially separated.

### LIST OF REFERENCE CHARACTERS

1. Housing
2. Wall
3. Cooking chamber
4. Viewing window
5. Muffle
6. Muffle opening
7. Base unit door
8. Countertop
9. Drive motor
10. Lifting element
11. Control element
12. Control panel
13. Control circuit
14. Display elements
15. Cooking zone
16. Cooking zone heating element
17. Cooking zone heating element
18. Surface heating element
19. Glass ceramic plate
20. Retaining element
21. Cooking appliance bracket
22. Lower telescopic rod element
23. Upper telescopic rod element
24. Zero point switch
25. Displacement switch field
25a. Displacement switch field above
25b. Displacement switch field below
27. Storage unit
28. Actuation key
29. Main switch
30. Motor shaft
31. Hall element
32. Measuring sensor
33. Carcass
34. Overlay
dend End region gap width
P0 Zero position
P1 Intermediate position
P2 Intermediate position
PZ Final position

1-13. (canceled)

14. A cooking appliance, especially a built-in wall-mounted cooking appliance, having at least one muffle defining a cooking compartment and being formed with a muffle opening, a door for movement into and out of a covering relationship with the muffle opening, a drive device for moving the door, a control device for controlling operation of the drive device to control door movement, the cooking appliance comprising at least one switch operationally disposed for actuation when the door contacts the muffle and thereby provide a zero door position indication signal to the control device, wherein presence of the zero door position indication signal is required but not sufficient to fully establish a zero door position within the control device.

15. The cooking appliance according to claim 14 wherein the control device is configured to determine a zero door position if the at least one switch is actuated and a measurement of a displacement path of the door simultaneously indicates that the zero position has been reached at least within a certain tolerance range.

16. The cooking appliance according to claim 15 and further comprising means for determining door displacement by measuring a number of revolutions of a motor or a fraction thereof.

17. The cooking appliance according to claim 16 wherein the means for determining door displacement includes at least one sensor unit, especially a Hall sensor unit, for measuring a revolution speed of a motor shaft or a fraction thereof, wherein the sensor is in operational communication with the control device.

18. The cooking appliance according to claim 17 wherein the control device includes means for counting the sensor pulses transmitted by the control device based on an initial zero position and converts the sensor pulses into a displacement value when the door is moved.

19. The cooking appliance according to claim 14 wherein the control device is configured for deciding that a zero position is fully established when the at least one switch is actuated and the door cannot be moved further while simultaneously actuating the drive device.

20. The cooking appliance according to claim 19 wherein the control device is configured to determine and establish a stationary state of the door based on a stationary state of the drive device.

21. The cooking appliance according to claim 14 wherein the at least one switch includes two switches, each switch being operationally attached to a respective side of the cooling appliance, with the presence of the actuation signals of both switches being required but not being sufficient to fully establish a zero position of the door by the control device.

22. The cooking appliance according to claim 14 wherein the at least one switch is fixedly connected to the muffle and is actuated by a lifting element, especially by a telescopic rail.

23. The cooking appliance according to claim 14 wherein the cooling appliance is formed as a built-in wall-mounted cooking appliance and the muffle opening is formed on the base side of the appliance and the door is a base unit door.

24. A method for determining a zero position of a door of a cooking appliance, the method comprising the steps of providing at least one muffle defining a cooking compartment and being formed with a muffle opening, a door for movement into and out of a covering relationship with the muffle opening, a drive device for moving the door, a control device for controlling operation of the drive device to control door movement, and at least one switch operationally disposed for actuation when the door contacts the muffle and thereby provide a zero door position indication signal to the control device, wherein presence of the zero door position indication signal is required but not sufficient to fully establish a zero door position within the control device; and
determining the zero position of the door when the at least one switch has been actuated simultaneously with measuring a door displacement wherein the door displacement door corresponds to the zero position at least within a tolerance range and/or the door cannot travel further when the drive device is actuated.

25. The method according to claim 24 wherein after the step of determining the zero position, describing the zero position as the precise new zero position.

26. The method according to claim 24 and further comprising the step of determining a fault wherein if the switch is actuated and at least one of the displacement path of the door corresponds to the zero position at least within a tolerance range and the door cannot travel further when the drive device is actuated does not apply or if the switch is not actuated, and both the displacement path of the door corresponds to the zero position at least within a tolerance range and the door cannot travel further when the drive device is actuated.
